(19) United States
(12) Patent Application Publication
(10) Pub. No.: US 2006/0103539 A1
(43) Pub. Date: May 18, 2006

(54) Vision recognition support device

(75) Inventors: Kazuyoshi Isaji, Kariya-city (JP); Naohiko Tsuru, Handa-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/257,465

(22) Filed: Oct. 24, 2005

(30) Foreign Application Priority Data
Nov. 4, 2004 (JP) 2004-321148

(51) Int. Cl. G08B 23/00; B60Q 1/00

(52) U.S. Cl. 340/575; 340/425.5

(57) ABSTRACT

The vision recognition support device includes an obscuring device configured to obscure a view of an operator operating an apparatus, and may further include a control device controlling operation of the obscuring device to temporarily obscure the view of the operator.

### FOREIGN PRIORITY INFORMATION

This application claims priority on Japanese Patent Application No. 2004-321148 filed on Nov. 4, 2004; the entire contents of which are hereby incorporated by reference.

### BACKGROUND OF THE INVENTION

Conventionally, driver alert systems have been proposed. These driver alert systems judge when a driver has become inattentive to visual information used in driving, and if the driver has become inattentive, the system provides an alert to the driver. A driver may become inattentive due to use of a cellular phone or by talking with a passenger, for example.

For example, JP 11-276461A describes a driver alert system that monitors a driver's eye movement. More specifically, the system monitors the frequency of a driver's eye movement, and from this, the system judges whether a driver is becoming visually inattentive with respect to the task of driving. When a driver's attentiveness level is falling, and the driver's ability to process external information is falling, the system provides the user with an alert. For example, a heads up projection may be displayed on the windshield or a tone may be output. However, this may not be sufficient for the user to visually recognize a dangerous situation such as impending impact with another vehicle or obstacle.

### SUMMARY OF THE INVENTION

The present invention relates to a vision recognition support device.

In one embodiment, the vision recognition support device includes an obscuring device configured to obscure a view of an operator operating an apparatus.

The embodiment may also include a control device controlling operation of the obscuring device to temporarily obscure the view of the operator. For example, the control device may receive information regarding the operator and determine whether to activate the obscuring device to temporarily obscure the view of the operator based on the received information. The information on the operator may come from an operator attentiveness level detecting device, and the control device determines to activate the obscuring device when the detected attentiveness level falls.

As another example, the control device may receive information regarding the apparatus and determines whether to activate the obscuring device to temporarily obscure the view of the operator based on the received information. The information on the apparatus may come from an apparatus state detecting system detecting an operating state of the apparatus, and/or a collision detecting device detecting if a collision situation exists between apparatus with an object.

As an example, the apparatus may a vehicle and the operator may be a driver of the vehicle. In this example, the obscuring device may be employed at one of a windshield and a side window of the vehicle.

### BRIEF DISCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates a block diagram of a vision recognition support system according to an embodiment of the present invention.

FIG. 2 illustrates a block diagram of the control device in FIG. 1 according to an embodiment of the present invention.

FIG. 3 illustrates the obscuring device of FIG. 1 according to an embodiment of the present invention.

FIGS. 4(a) and 4(b) illustrate graphs for explaining example triggering conditions and activation schemes for the obscuring device of FIG. 1.

FIG. 5 illustrates a flow chart of an example embodiment of the vision recognition methodology employed by the vision recognition support system of FIG. 1.

FIG. 6 illustrates, by comparison, the operation of the vision recognition support system of FIG. 1.

### DETAILED DESCRIPTION OF EXAMPLE EMBODIMENTS

Now referring to the drawings, an explanation will be given of various example embodiments of the present invention.

Hereafter, the embodiments of the vision recognition support system of this invention are explained using the example of a driver of vehicle, such as a car. However, the present invention may be employed in various forms, and this invention is not limited to a vision recognition support system for the driver of vehicle. For example, the system may be employed to support vision recognition in any situation where an operator's vision recognition is required for proper operation of an apparatus such as a vehicle, a manufacturing machine, etc.

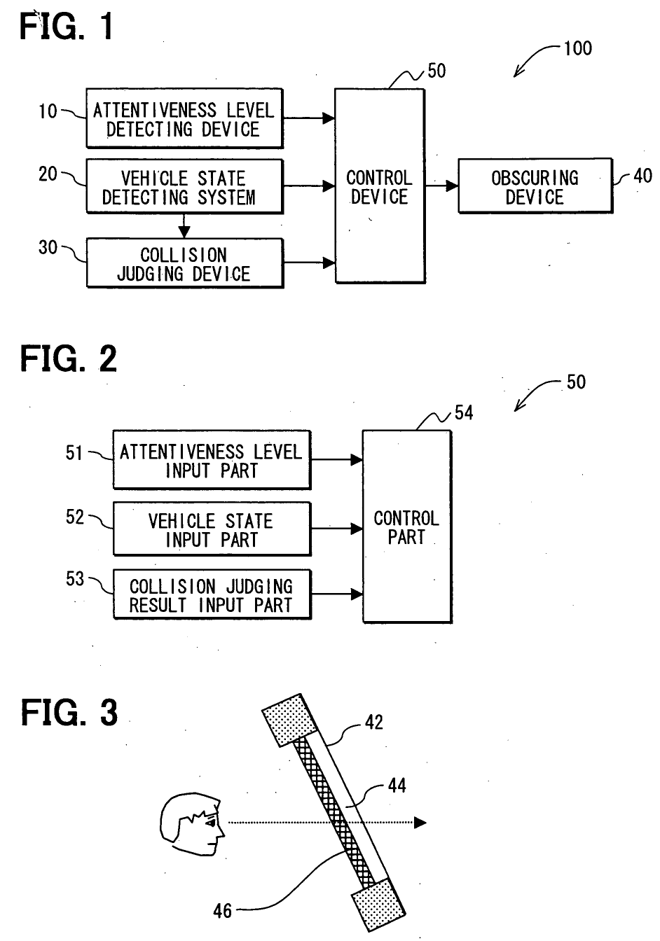

FIG. 1 illustrates a block diagram of a vision recognition support system according to an embodiment of the present invention. In this example embodiment, the vision recognition support system is employed in a vehicle such as an automobile to assist vision recognition of a driver. As shown, the system includes an attentiveness level detecting device 10, a vehicle state detecting system 20, a collision judging device 30 supplying input to a control device 50, and further includes a obscuring device 40 controlled by the control device 50.

The attentiveness level detecting device 10 detects the driver's attentiveness level to the vision information used in driving a vehicle. For example, the attentiveness level detecting device 10 may be the same as that employed in JP11-276461A. However, the attentiveness level detecting device 10 may be any well-known attentiveness level detecting device such as that disclosed in US Published Application No. 2003/0146841 A1, which is hereby incorporated by reference in its entirety. Accordingly, as described above, the attentiveness level detecting device 10 may detect the driver's eye movement, and determine whether the driver's attentiveness is falling based on the frequency of the detected eye movement. Namely, the attentiveness level detecting device 10 may judges a level of the driver's attentiveness (e.g., high, normal, low etc.) based on the frequency of detected eye movement. The attentiveness level detecting device 10 outputs this detected attentiveness level to the control device 50.

The vehicle state detecting system 20 may include a number of vehicle sensors that indicate the state of the vehicle. For example the vehicle state detecting system 20 may include a speed sensor sensing a speed of the vehicle, a transmission position sensor detecting the position of the vehicle's gearbox, a acceleration sensor detecting acceleration/deceleration of the vehicle, a steering sensor detecting an amount of steering from a neutral position, a radar (i) detecting proximity and/or direction of objects (e.g., other vehicles) in front of the vehicle and/or (ii) detecting proximity and/or direction of objects to either or both sides of the vehicle, and an imaging sensor sensing the image in front of the vehicle and detecting therefrom a position of the vehicle in the vehicle's current running-lane. As each of the above-described sensors are well-known in the art, as is there location in a vehicle, these sensor and there locations in a vehicle will not be described in detail for the sake of brevity. The vehicle state detecting system 20 supplies the output from the sensors in the system 20 to the collision judging device 30 and the control device 50. Furthermore, it will be understood that the sensors used in detecting the operation state of the apparatus will vary depending on the apparatus.

Using the information from the vehicle state detecting system 20, the collision judging device 30 judges the possibility of collision between the vehicle and an object (e.g., another vehicle) that exists in front of or to the side of the vehicle. The collision judging device 30 may be any well-known collision judging device. And, because such collision judging devices are so well-known in the art, the collision judging device 30 will not be described in detail for the sake of brevity.

Based on the input received from the attentiveness level detecting device 10, the vehicle state detecting system 20 and the collision judging device 30, the control device 50 controls operation of the obscuring device 40. The control device 50 will be described in greater detail below with respect to FIG. 2. The obscuring device 40 is applied to one or more viewing fields of the apparatus being operated by the operator. For example, the obscuring device 40 may be applied to a windshield of the vehicle. However, the obscuring device 40 may be provided in the front windshield, the side window, and/or etc. As is known, the driver views the image in front of the vehicle through the front windshield and views the image to a side of the vehicle through the side window. The obscuring device 40 when activated obscures the driver's view through the viewing field to which the obscuring device 40 is applied. For example, the obscuring device 40 may cloud or shade the driver's view through the windshield or window, or the obscuring device 40 may block the driver's view. Accordingly, as an alternative, the obscuring device 40 may be formed on a driver's glasses, for example.

FIG. 3 illustrates an example embodiment of the obscuring device 40 applied to a front windshield of the vehicle. As shown, the obscuring device 40 includes a shielding sheet 42 applied to an outer surface of a windshield 44, and a transparent EL (Electronic Luminescent) display 46 applied to an inner surface of the windshield 40. The shielding sheet 42 reduces the light volume entering from outside the vehicle via the windshield 44. The use of the shielding sheet 42 is optional, but serves to heighten the obscuring effect provided by the transparent EL display 46 as described below. Furthermore, instead of on the outside of the windshield 44, the shielding sheet 42 may be provided between the transparent EL display 46 and the windshield 44.

The transparent EL display 46, when deactivated, is transparent, and does not obscure the driver's vision. However, when activated, the transparent EL display 46 may obscure or, alternatively, block the driver's vision. As is known, activating the transparent EL display 46 generally requires application of voltage to the EL matrix forming a part of the transparent EL display 46. Accordingly, in case of a failure in the vehicle's electrical system, the transparent EL display 46 remains transparent by default. Because transparent EL displays are well-known in that art, the transparent EL display 46 will not be described in detail for the sake of brevity. Also, it will be understood that the present invention is not limited to a transparent EL display as the obscuring device 40. Instead, any system that allows for selectively obscuring or blocking a driver's view may be used.

As stated above, the control device 50 controls the operation of the obscuring device 40. The control device 50 may be implemented as a microcomputer where the microcomputer includes a bus line connecting well-known elements such as a CPU, ROM, RAM, I/O, etc. The program for operation of the vision recognition support system 100 is written in the ROM. According to this program, the CPU etc. performs operation processing as described in more detail below.

FIG. 2 illustrates a block diagram of the control device 50 according to one embodiment of the present invention. As shown, the control device 50 includes an attentiveness level input part 51, a vehicle state input part 52 and a collision judging result input part 53 connected to a control part 54. The attentiveness level input part 51 acquires the driver's attentiveness level (for example, high, normal, low, etc.) output from the attentiveness level detecting device 10. The vehicle state input part 52 acquires the vehicle state information output from the vehicle state detecting system 20. The collision judging result input part 53 acquires a collision detection result output from the collision judging device 30. The control part 54 controls an operation (e.g., activation and deactivation) of the obscuring device 40 based on the information acquired by the attentiveness level input part 51, the vehicle state input part 52, and the collision judging result input part 53.

The control part 54 controls the obscuring device 40 while the vehicle is running. More specifically, the control part 54 selectively activates the obscuring device 40. For example if the driver's attentiveness level changes from high or normal to low, the control part 54 may activate and then deactivate the obscuring device to temporarily obscure or block the driver's view. As another example, if the collision judging device 30 indicates a possible collision with an object, the control part 54 temporarily activates the obscuring device 40 to temporarily obscure or block the driver's view of the object. This may seem counterintuitive, but serves to present the driver with a greater, more discrete or stepwise change of the image viewed by the driver. Because the driver should perceive a greater change in the viewed image, the driver may more readily ascertain or recognize the situation being faced, and react accordingly.

Depending on the condition leading to activation of the obscuring device 40 and the vehicle state as indicated by the vehicle state detecting system 20, the length of time with which the obscuring device 40 is activated may change. Also, instead of a single activation, the control part 54 may repeatedly activate and deactivate the obscuring device 40, with the length of activation and deactivation being controlled by the control part 54.

As will be appreciated, the conditions established to trigger activation and deactivation of the obscuring device are a matter of design choice, as are the operational parameters (e.g., length of activation) of the obscuring device for each condition. As will further be appreciated, these conditions and parameters may be established empirically according to routine testing.

For example, the vehicle speed, and the distance and the time to an object for which a collision possibility has been detected, are useful metrics for determining whether a triggering condition exits. As another example, the object is perceived as having a certain area within the driver's field of view. As is known, this area may be determined from the output of the imaging sensor in the vehicle state detecting system 20. Accordingly, another useful metric for determining a triggering condition may be the rate of change in the area of the object's image.

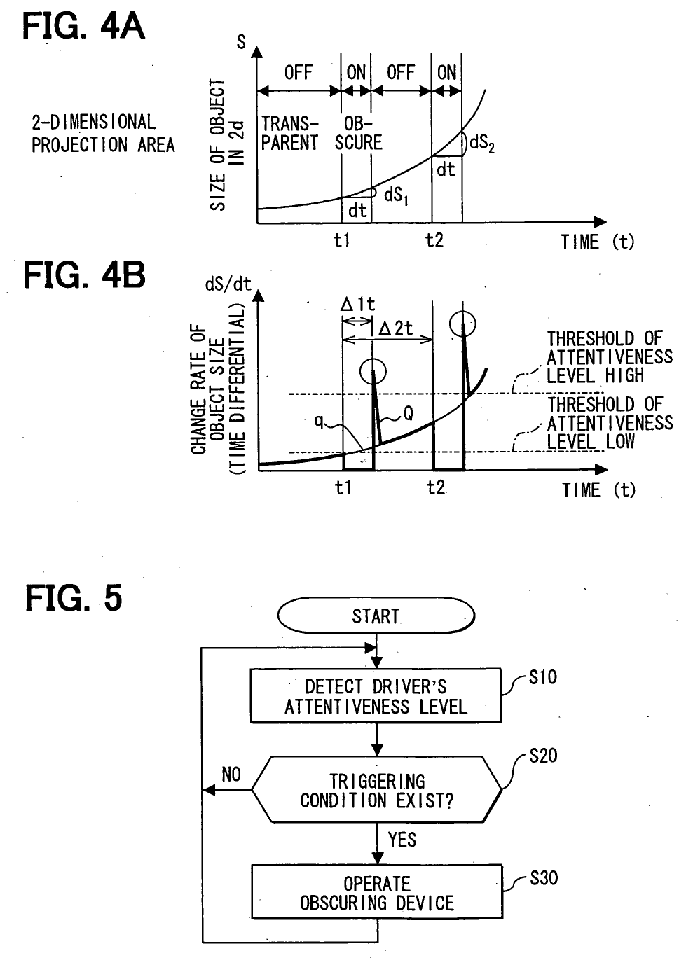

For the purposes of example only, example triggering conditions and operational parameters associated therewith will be described with respect to FIGS. 4(a) and 4(b). In this example, the control part 54 at least compares the rate of change in area of an imaged object (e.g., another vehicle) against a threshold to determine whether to trigger an activation scheme for the obscuring device 40. In FIG. 4(b), the Y-axis represents the change in area for the imaged object and the X-axis represents time. FIG. 4(b) illustrates two thresholds by dashed lines. The lower threshold is used when the driver's detected attentiveness level is low, and the higher threshold is used when the driver's detected attentiveness level is high. FIG. 4(b) further illustrates by a curve “q” an example of the change in area of an imaged object over time, and illustrates by a darker curve “Q” the driver's perceived change in the area of the object over time as a result of the operation of the obscuring device 40. In the example shown by curve “q”, the vehicle driven by the driver is approaching an object (e.g., another vehicle) such that the area of the object imaged by the image sensor in the vehicle state detecting system 20 increases over time.

Assuming the driver's attentiveness level is high and the lower threshold is used, then at time t1 when the change in area of the imaged object reaches the threshold, the control part 54 activates the obscuring device 40. As shown by curve “Q” the driver's perceived change in area of the object drops to zero because the driver's view of the object is obscured. However, as shown by curve “q”, the rate of change in the area of the imaged object continues to increase.

In this embodiment, the control part 54 activates the obscuring device 40 for a period to time Δ1t, such that at time t1+Δ1t the obscuring device 40 is deactivated. As shown by curve “Q” in FIG. 4(b), the driver perceives a large spike in the rate of change in the area of the object at this time. By contrast, as shown by curve “q”, absent the activation of the obscuring device 40, the perceived rate of change would be quite small and gradual. Accordingly, the present invention greatly assist the driver in recognizing a possible collision with an object.

As further shown by FIG. 4(b), assuming no corrective action by the driver, the control part 54 may employ an activation scheme that causes the control part 54 to activate the obscuring device 40 again at a time t2, which is Δ2t from time t1, and the obscuring device 40 is again activated for a period of time Δ1t.

FIG. 4(a) provides a companion graph to FIG. 4(b) with the size (e.g., area) of the object's image represented along the Y-axis and time represented along the X-axis.

Next, processing performed by the control part 54 will be described with respect to FIG. 5. As shown, in step S10 a driver's attentiveness level is detected by the driver attentiveness level detecting device 10. At vehicle start-up, the attentiveness level is set to high by default programming. Then, in step S20 the control part 54 judges whether a triggering condition exits. For example, the control part 54 may judge whether the driver's attentiveness level is falling, or judge whether a collision possibility with other objects exists. As discussed above, the control part 54 may employ the thresholding technique described above with respect to FIG. 4(b) to judge a collision triggering condition. If a triggering condition exists, then in step S30, the control part 54 activates the obscuring device 40 according to an activation scheme such as the activation scheme described above with respect to FIG. 4(b). On the other hand, in step S20, if no triggering condition exists, processing returns to Step 10.

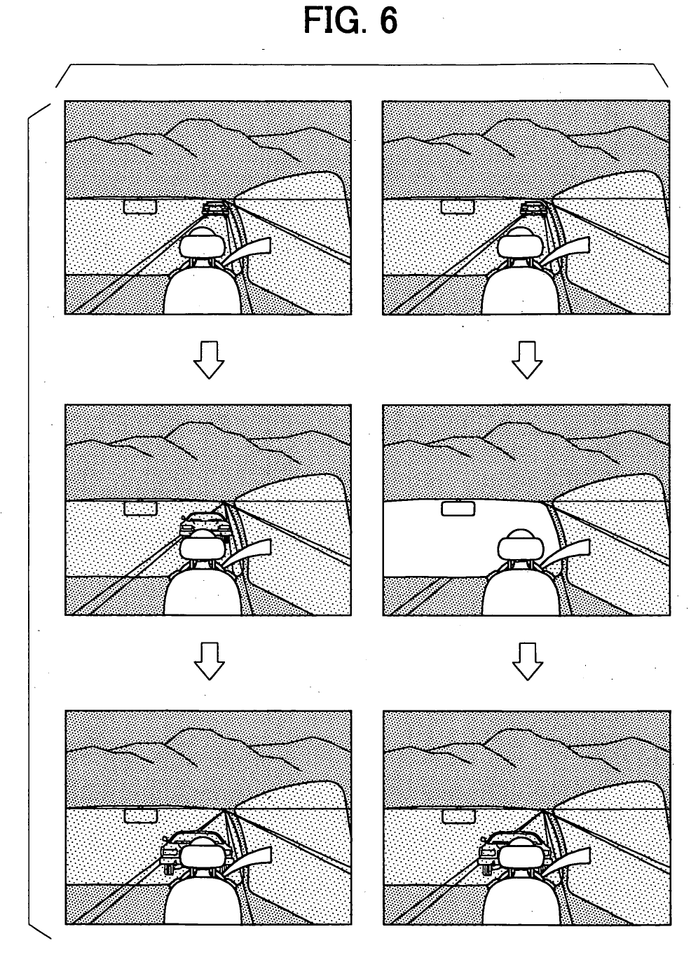

FIG. 6 illustrates comparable images in time on the left and right hand side. The left hand side illustrates the view a driver sees when the present invention is NOT employed. The right hand side illustrates the view a driver sees when the present invention is employed. Accordingly, as shown by the left hand side of FIG. 6, when the obscuring device 40 does not operate, the driver sees a gradual change in the size of an vehicle in front of him. On the other hand, when the obscuring device 40 operates, the driver sees a large, discrete or step-wise change in the area of the vehicle in front of him. Therefore, a driver easily recognizes a situation requiring the driver's attention.

The invention being thus described, it will be obvious that the same may be varied in many ways. Such variations are not to be regarded as a departure from the spirit and scope of the invention, and all such modifications as would be obvious to one skilled in the art are intended to be included within the scope of the invention.

What is claimed is:

1. A vision recognition support device, comprising:
an obscuring device configured to obscure a view of an operator operating an apparatus.

2. The device of claim 1, further comprising:
a control device controlling operation of the obscuring device to temporarily obscure the view of the operator.

3. The device of claim 2, wherein the control device receives information regarding the operator and determines whether to activate the obscuring device to temporarily obscure the view of the operator based on the received information.

4. The device of claim 3, further comprising:
an operator attentiveness level detecting device detecting an attentiveness level of the operator; and wherein
the control device determines whether to activate the obscuring device based on the detected attentiveness level.

5. The device of claim 4, wherein the control device determines to activate the obscuring device when the detected attentiveness level falls.

6. The device of claim 4, wherein the obscuring device is configured to block the view of the operator.

7. The device of claim 4, wherein the apparatus is a vehicle and the operator is a driver of the vehicle.

8. The device of claim 7, wherein the obscuring device is employed at one of a windshield and a side window of the vehicle.

9. The device of claim 2, wherein the control device receives information regarding the apparatus and determines whether to activate the obscuring device to temporarily obscure the view of the operator based on the received information.

10. The device of claim 9, further comprising:
an apparatus state detecting system detecting an operating state of the apparatus; and wherein
the control device receives information representing the detected operating state from the apparatus state detecting system and determines whether to activate the obscuring device to temporarily obscure the view of the operator based on the received information.

11. The device of claim 10, wherein the apparatus is a vehicle and the operator is a driver of the vehicle.

12. The device of claim 11, wherein the apparatus state detecting system detects at least one of a speed of the vehicle and an image in front of the vehicle.

13. The device of claim 11, wherein the obscuring device is employed at one of a windshield and a side window of the vehicle.

14. The device of 9, further comprising:
a collision detecting device detecting if a collision situation exists, the collision situation being a possible collision of the apparatus with an object; and wherein
the control device determines whether to activate the obscuring device to temporarily obscure the view of the operator based on the output of the collision detecting device.

15. The device of claim 14, wherein the apparatus is a vehicle and the operator is a driver of the vehicle.

16. The device of claim 15, wherein the obscuring device is employed at one of a windshield and a side window of the vehicle.

17. A vision recognition support device, comprising:
an obscuring device configured to obscure a view of an operator operating an apparatus;
an attentiveness level detecting device detecting an attentiveness level of the operator;
an apparatus state detecting system detecting an operating state of the apparatus; and
a collision detecting device detecting if a collision situation exists, the collision situation being a possible collision of the apparatus with an object; and
a control device controlling operation of the obscuring device based on outputs from the attentiveness level detecting device, the apparatus state detecting system and the collision detecting device.

18. The device of claim 17, wherein the apparatus is a vehicle and the operator is a driver of the vehicle.
